(19) United States
(12) Patent Application Publication
(10) Pub. No.: US 2017/0024775 A1
(43) Pub. Date: Jan. 26, 2017

(54) VALUING DISTRIBUTION DATA

(71) Applicant: Google Inc., Mountain View, CA (US)

(72) Inventors: Sergei Vassilvitskii, Mountain View, CA (US); Patrick Hummel, Mountain View, CA (US); Kshipra Uday Bhawalkar, Mountain View, CA (US)

(73) Assignee: Google Inc., Mountain View, CA (US)

(21) Appl. No.: 13/948,635

(22) Filed: Jul. 23, 2013

(51) Int. Cl. G06Q 30/02

(52) U.S. Cl. CPC G06Q 30/0275

(57) ABSTRACT

Methods, systems, and apparatus, including computer programs encoded on computer storage media, for valuing distribution data. One of the methods includes receiving first information describing a desired market. The method includes receiving second information describing a group of users. The method includes receiving third information describing a competitive environment. The method includes determining a first measure of monetary value associated with providing content items to the group of users without using the second information. The method includes determining a second measure of monetary value associated with providing content items to the group of users using the second information. The method includes calculating a value for the second information based on the first measure and the second measure.

### TECHNICAL FIELD

This document generally relates to information presentation.

### BACKGROUND

Content providers obtain value by presenting content items to users. Certain users are more receptive to certain content items. Content providers may increase the value of presenting content items if they can present content items to users who are more likely to be receptive to the content.

### SUMMARY

In general, one innovative aspect of the subject matter described in this specification can be embodied in methods that include the actions of receiving, by a computer system, first information describing a desired market. The methods include the actions of receiving, by the computer system, second information describing a group of users. The methods include the actions of receiving, by the computer system, third information describing a competitive environment. The methods include the actions of determining a first measure of monetary value associated with providing content items to the group of users without using the second information. The methods include the actions of determining a second measure of monetary value associated with providing content items to the group of users using the second information. The methods include the actions of calculating a value for the second information based on the first measure and the second measure. The methods include the actions of outputting the value.

Other embodiments of this aspect include corresponding computer systems, apparatus, and computer programs recorded on one or more computer storage devices, each configured to perform the actions of the methods. A system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

The foregoing and other embodiments can each optionally include one or more of the following features, alone or in combination. Calculating the value may include determining, using the third information, a likelihood that a competitor will place a bid at a price between the first measure and the second measure. The methods may include the actions of receiving fourth information describing the group of users. The methods may include the actions of calculating a second value for the fourth information based on the first information, the second information, and the third information. The methods may include the actions of receiving a measure of quality associated with the first information. The value may be further based on the measure of quality. The value may be further based on a budgetary constraint. Determining a second measure of monetary value may be based at least in part on a probability that an identified user is part of the desired market.

### DESCRIPTION OF DRAWINGS

FIG. 1 is a block diagram of an example of an online content delivery system.

FIG. 2 illustrates an example of a process by which a publisher evaluates the value of distribution data.

FIG. 3 illustrates an example of a component that determines a value for distribution data.

FIG. 4 is a flow chart of a process for determining a value for distribution data.

Like reference symbols in the various drawings indicate like elements.

### DETAILED DESCRIPTION

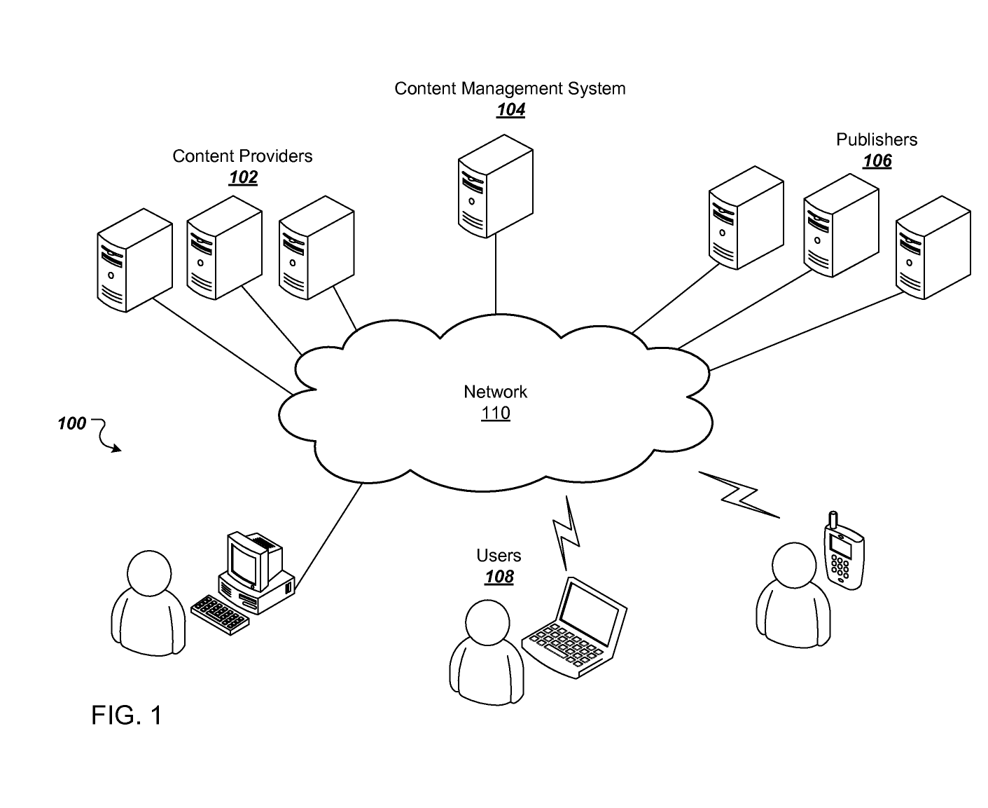

FIG. 1 is a block diagram of an example online content delivery system 100. In some implementations, one or more content providers (e.g., advertisers) 102 can directly, or indirectly, enter, maintain, and distribute content (e.g., advertisement or “ad”) information in a content management system 104. Though reference is made in numerous places in this document to advertising, other forms of content, including other forms of sponsored content, can be delivered by the system 100. The content may be in the form of graphical ads, such as banner ads, text only ads, image ads, audio ads, video ads, ads combining one or more of any of such components, etc. The content may also include embedded information, such as a link, meta-information, and/or machine executable instructions. One or more publishers 106 may submit requests for content to the content management system 104. The content management system 104 responds by sending content to the requesting publisher 106 (or directly to an end user) for placement on one or more of the publisher's web properties (e.g., websites or other network-distributed content). The content can include embedded links to landing pages, e.g., pages on the content providers 102 websites, that a user is directed to when the user clicks or otherwise interacts with a content item presented on a publisher website.

A computer network 110, such as a local area network (LAN), wide area network (WAN), the Internet, or a combination thereof, connects the content providers 102, the content management system 104, the publishers 106, and the users 108.

One example of a publisher 106 is a general content server that receives requests for content (e.g., articles, discussion threads, music, video, graphics, search results, web page listings, information feeds, etc.), and retrieves the requested content in response to the request. The content server (or a user that is accessing the content source by way of a redirect) may submit a request for one or more content items (e.g., ads) to a content server in the content management system 104. The request may include a number of content items desired. The request may also include content request information. The content request information can include the content itself (e.g., page or other content document), a category corresponding to the content or the content request (e.g., arts, business, computers, arts-movies, arts-music, etc.), part or all of the content request, content age, content type (e.g., text, graphics, video, audio, mixed media, etc.), geo-location information, etc.

In some implementations, the content server can combine the requested content with one or more of the content items provided by the content management system 104. This combined content can be sent to the user 108 that requested the content for presentation in a viewer (e.g., a browser or other content display system). Alternatively, the content can be combined at a user's device (e.g., by combining in a user's browser content from the content source with content items provided by the content management system 104). The content server can transmit information about the content items back to the content server, including information describing how, when, and/or where the content items are to be rendered (e.g., in HTML or JavaScript™).

Another example publisher 106 is a search service. A search service can receive queries for search results. In response, the search service can retrieve relevant search results from an index of documents (e.g., from an index of web pages). An exemplary search service is described in the article S. Brin and L. Page, “The Anatomy of a Large-Scale Hypertextual Search Engine,” Seventh International World Wide Web Conference, Brisbane, Australia and in U.S. Pat. No. 6,285,999, both of which are incorporated herein by reference each in their entirety. Search results can include, for example, lists of web page titles, snippets of text extracted from those web pages, and hypertext links to those web pages, and may be grouped into a predetermined number of (e.g., ten) search results.

The search service can submit a request for content items to the content management system 104. The request may include a number of content items desired. This number may depend on the search results, the amount of screen or page space occupied by the search results, the size and shape of the content items, etc. In some implementations, the number of desired content items will be from one to ten, or from three to five. The request may also include the query (as entered or parsed), information based on the query (such as geo-location information, whether the query came from an affiliate and an identifier of such an affiliate), and/or information associated with, or based on, the user or the search results. Such information may include, for example, identifiers related to the search results (e.g., document identifiers or “docIDs”), scores related to the search results (e.g., information retrieval (“IR”) scores), snippets of text extracted from identified documents (e.g., web pages), full text of identified documents, feature vectors of identified documents, etc. In some implementations, IR scores can be computed from, for example, dot products of feature vectors corresponding to a query and a document, page rank scores, and/or combinations of IR scores and page rank scores.

The search service can combine the search results with one or more of the content items provided by the content management system 104. This combined information can then be forwarded to the user 108 that requested the content. The search results can be maintained as distinct from the content items, so as not to confuse the user between paid content and presumably neutral search results.

The search service can also transmit information about the content items and when, where, and/or how the content items were rendered back to the content management system 104.

In some examples, the content management system 104 may include an auction process to select content. Content providers (e.g., advertisers) may be permitted to select, or bid, an amount the providers are willing to pay, for example, for interaction with a provided content item (e.g., for each click of an advertisement as a cost-per-click amount an advertiser pays when, for example, a user clicks on an advertisement).

In some examples, content providers may wish to deliver content items to a user based on factors such as geographic locations that the user has previously visited, hobbies and interests, etc. Such techniques can be combined with other techniques for selecting and distributing content items, such as keyword quality matching, a user's browsing habits, and the bid and auction processes described above.

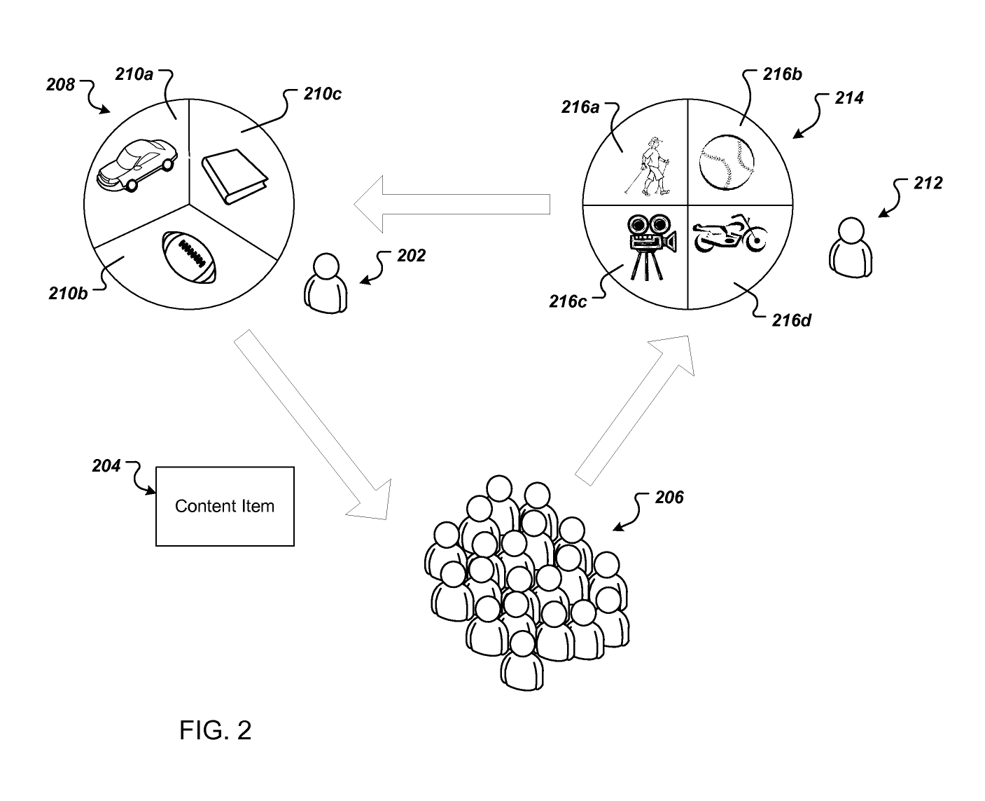

FIG. 2 illustrates an example of a process by which a content provider evaluates the value of distribution data. A content provider 202 presents content items (for example the content item 204) to a group of users 206. Different users may be receptive to different kinds of content. For example, information about the latest car may be of limited use to someone who only commutes by bike. A sale on umbrellas is likely not interesting to someone who lives in the desert. The content provider 202 may have a profile 208 that describes users who are likely to be receptive to particular content items. In this example, the profile 208 of the content provider 202 is presented as a pie chart. Different segments of the chart correspond to different characteristics of users. The content provider 202 identifies users who are interested in cars 210a, sports 210b, or books 210c. In this example, the content provider may have determined that users who are interested in cars 210a are not likely to be interested in the same content items as users who are interested in books 210c. Content providers generally know the audience for their content items. For example, the content provider 202 may have determined they wish to present content to the users interested in sports 210b.

A data provider 212 may have distribution data 214 about the interests and/or characteristics of users in a group of users 206. The distribution data may identify interests, hobbies, demographic information, or any other information that can be used to segment a group of users. However, the distribution data 212 may not correspond directly to the profile 208. For example, the distribution data 212 may identify users who have expressed an interest in outdoor activities 216a, users who have expressed an interest in baseball 216b, users who have expressed an interest in movies 216c, and users who have expressed an interest in motorcycles 216d.

The distribution data 212 may not be completely accurate. For example, some users may be categorized in an incorrect grouping. The content provider has an interest in determining a value that the distribution data 212 being offered has for the content provider.

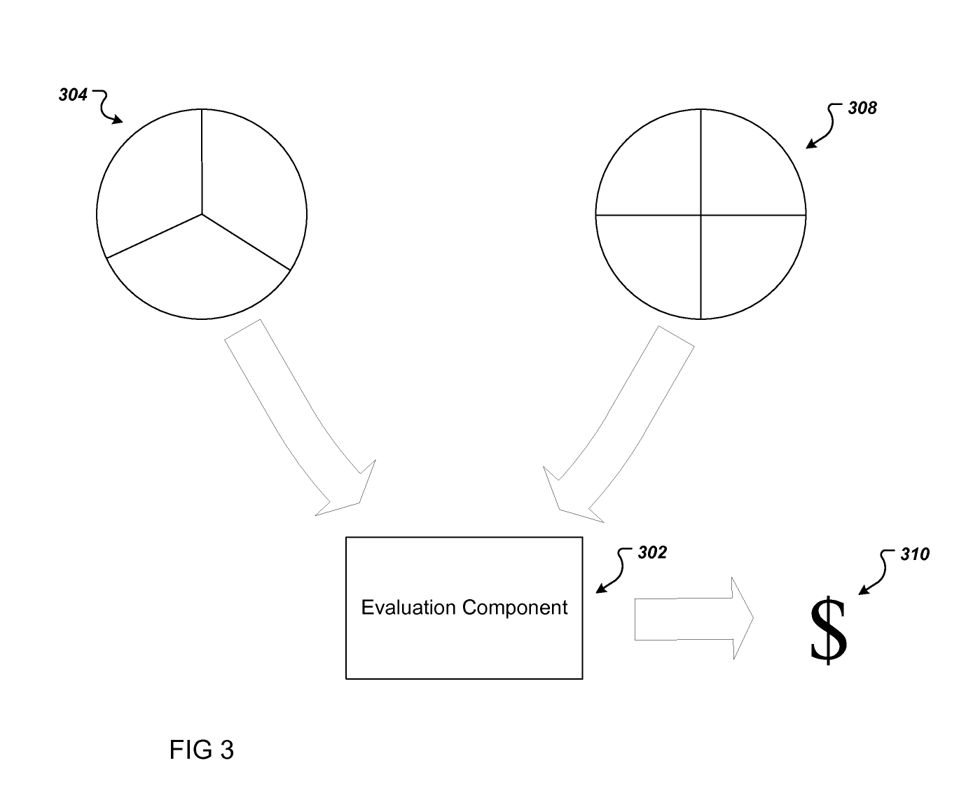

FIG. 3 illustrates an example of a component that determines a value for distribution data. An evaluation component 302 may receive information about the content provider's desired audience 304 and the distribution data 308 that may enable delivery of the content to the desired audience. The distribution data may include a description of the segmentation of a group of users. For example, the distribution data may group users into categories based on region of the country. The evaluation component 302 may be part of the content management system 104 of FIG. 1. Using the information provided, the evaluation component 302 can provide an indication of the value 310 of the distribution data provides to the content provider.

The value can be based upon several factors, including, the value the content provider obtains from delivering content to different groups identified by the distribution data, the likelihood of a competing content provider offering a price that is between the price the content provider would offer without the distribution data and the price the content provider would offer with the distribution data, and the relative likelihoods of the different realizations of the distribution data.

For example, if there is a significant difference between the value a content provider obtains for providing content items to one user or the other then the distribution data is more valuable. In contrast, if there is not much difference between the value the content provider obtains for providing content items to different types of users, the distribution data holds less value.

If a competing content provider is likely to offer more than the content provider is willing to pay without the distribution data, but less than the content provider would be willing to pay with the distribution data, then the distribution data has more value (for example, the content provider may pay more and consequently deliver more content items to the users). In contrast, if a competing content provider is unlikely to offer a price between the amount the content provider is willing to pay without the distribution data and the amount the content provider is willing to pay with the distribution data, then having the distribution data will have little impact on the value realized by the content provider.

In some arrangements, the evaluation component 302 may evaluate distribution data that segments users into two groups, for example, people living in east of the Mississippi and people living west of the Mississippi, people living in the North and people living in the South, etc. Generally, the content provider may wish to distribute a content item to one of the two groups. That is, content items presented to one group may have a high value (the H group) while content items presented to the other group may have a low value (the L group). In general, without distribution data the value that a content provider receives from presenting a content item to a user in the group is determined based on a weighted average of historical returns for providing content items to the entire group. This value may be calculated using the formula:

ν̅=πν_{H}+(1−π)ν_{L},

where ν̅ is the value the content provider receives, π is the percentage of the users who are in the H group, ν_{H} is the value associated with providing content items to the high value group, and ν_{L} is the value associated with providing content items to the low value group. Alternatively, the value may be provided by the content provider.

A function, ƒ, denotes the probability density function of the price distribution for the highest amount content providers will pay to provide content items to the users.

Because a content provider will typically not bid more for a content item placement then the content provider receives in value, it can be assumed that the maximum price the content provider would typically pay is ν̅. Therefore, the value that the content provider obtains from providing content items to the entire group can be determined by the formula:

u_{ND}=π∫₀^{ν̅}(ν_{H}−p)ƒ(p)dp+(1−π)∫₀^{ν̅}(ν_{L}−p)ƒ(p)dp,

where u_{ND} is the value the content provider obtains without having access to the distribution data, π is the percentage of the users who are in the H group, ν̅ is the average value the content provider has received in the past and the amount the content provider is willing to bid, as described above, ν_{H} is the value associated with providing content items to the high value group, ν_{L} is the value associated with providing content items to the low value group, and ƒ(p) is the probability density function of the price distribution. In other words, the value that the content provider receives is all of the value that can be obtained up to the amount the content provider is willing to pay to provide content without the distribution data.

If the content provider had the distribution data, then the content provider will likely elect to pay one price to advertise to the high value group and a second price to advertise to the low value group. In this case, the value that the content provider obtains from providing content items to the entire group can be determined by the formula:

u_{D}=π∫₀^{ν}^{_{H}}(ν_{H}−p)ƒ(p)dp+(1−π)∫₀^{ν}^{_{L}}(ν_{L}−p)ƒ(p)dp,

where u_{D} is the value the content provider obtains with the distribution data, π is the percentage of the users who are in the H group, ν_{H} is the value associated with providing content items to the high value group, ν_{L} is the value associated with providing content items to the low value group, and ƒ(p) is the probability density function of the price distribution.

The increased value the content provider obtains from the distribution data can be calculated using the formula:

u_{D}−u_{ND},

which is equal to:

π(∫₀^{ν}^{_{H}}(ν_{H}−p)ƒ(p)dp−∫₀^{ν̅}(ν_{H}−p)ƒ(p)dp)+(1−π)(∫₀^{ν}^{_{L}}(ν_{L}−p)ƒ(p)dp−∫₀^{ν}(ν_{L}−p)ƒ(p)dp)=π∫_{ν̅}^{ν}^{_{H}}(ν_{H}−p)ƒ(p)dp+(1−π)∫_{ν}_{_{L}}^{ν̅}(ν_{L}−p)ƒ(p)dp.

In this expression, the first term represents the value of the extra impressions that the content provider wins by paying more when the content provider learns that the value for a user is higher than average, and the second term gives the value of the savings that the content provider obtains from not paying too much for impressions where the value is lower than average.

In some arrangements, the evaluation component 302 may account for the possibility that the distribution data is incomplete or inaccurate. The evaluation component 302 may also value data that is considered accurate, but that does not align with the content providers need. For example, a content provider may wish to advertise to users in Maine, Massachusetts, Connecticut, Rhode Island, New Hampshire, and Vermont. However, the distribution data only identifies whether the users are in Maine, Massachusetts, Connecticut, Rhode Island, New Hampshire, Vermont, Pennsylvania, and New York.

In this example, the evaluation component 302 may adjust the probabilities that a user belongs to the H group, given that the distribution data indicates the user is a member of group H to be:

$$π \text{\textbar} h = \frac{ q}{π q + ( 1 - π ) ( 1 - q )} ,$$

where q is the probability that any particular user is correctly categorized or in the correct group.

The evaluation component 302 may adjust the probabilities that a user belongs to the H group, given that the distribution data indicates the user is a member of the L group to be:

$$π \text{\textbar} l = \frac{ ( 1 - q )}{π ( 1 - q ) + ( 1 - π ) ( q )}$$

Therefore, it follows that the expected value the content provider can expect for an content item opportunity based on receiving an indication that the user is part of the H group can be calculated using the formula:

ν|h=(π|h)ν_{H}+(1−π|h)ν_{L}

Similarly, the expected value the content provider can expect for a content item opportunity based on receiving an indication that the user is part of the L group can be calculated using the formula:

ν|l=(π|l)ν_{H}+(1−π|l)ν_{L}

In this example, the value that the content provider receives without the distribution data remains the same as above and the value that the content provider receives from the distribution data can be calculated using the formula:

u_{D}πq∫₀^{ν|h}(ν_{H}−p)ƒ(p)dp+π(1−q)∫₀^{ν|l}(ν_{H}−p)+(1−π)q∫₀^{ν|l}(ν_{L}−p)ƒ(p)dp+(1−π)(1−q)∫₀^{ν|h}(ν_{L}−p)ƒ(p)dp,

where u_{D} is the value the content provider obtains with the distribution data, it is the percentage of the users who are in the H group, q is the probability that any particular user is correctly categorized, ν|h is the value of providing a content item to a user given that the distribution data indicates the user is in the H group, ν|l is the value of providing a content item to a user given that the distribution data indicates the user is in the L group, ν_{H} is the value associated with providing content items to the high value group, ν_{L} is the value associated with providing content items to the low value group, and ƒ(p) is the probability density function of the price distribution.

In this example, the increased value the content provider obtains from the distribution data can be calculated using the formula

∫_{ν̅}^{ν|h}(πq(ν_{H}−p)+(1−π)(1−q)(ν_{L}−p))ƒ(p)dp+∫_{ν|l}^{ν̅}(π(1−q)(ν_{H}−p)+(1−π)q(ν_{L}−p))ƒ(p)dp,

where π is the percentage of the users who are in the H group, q is the probability that any particular user is correctly categorized, ν|h is the value of providing a content item to a user given that the distribution data indicates the user is in the H group, ν|l is the value of providing a content item to a user given that the distribution data indicates the user is in the L group, ν_{H} is the value associated with providing content items to the high value group, ν_{L} is the value associated with providing content items to the low value group, and ƒ(p) is the probability density function of the price distribution.

As discussed above, content providers may compete against each other for placement opportunities by way of an auction. In some arrangements, the evaluation component 302 may determine the value of distribution data where there is a correlation between the content provider's value for a presentation opportunity and the highest competing bid the content provider is likely to encounter. This may occur because, for example, the desired audience may have characteristics that make presenting content items more or less valuable to multiple content providers.

The content provider's value for distribution data may depend on the content provider's value difference between placement opportunities with different realizations of the distribution data, the likelihood of a competing content provider placing a bid between those possible values, and the relative likelihoods of the different realizations of the distribution data.

The bids from other content providers provide an indication as to whether a user is in the H group or the L group. Using the variable ν* to represent the highest bid from a competing content provider then the probability that any given user is in the H group can be calculated using the formula:

$$\frac{π {f}_{H} ( {v}^{*} )}{π {f}_{H} ( {v}^{*} ) + ( 1 - π ) {f}_{L} ( {v}^{*} )} ,$$

where π is the is the fraction of users who are in the H group, ƒ_{H} represents a probability density function of a distribution of a highest competing bid placed by competing content providers for members of the H group, and ƒ_{L} represents a probability density function of a distribution of the highest competing bid placed by competing content providers for members of the L group.

In this example the value the content provider receives without the information may be calculated using the formula:

u_{ND}=π∫₀^{ν}(ν_{H}−p)ƒ(p)dp+(1−π)∫₀^{ν}(ν_{L}−p)ƒ(p)dp.

However, if the content provider does have access to the distribution data, then the content provider would place a bid of ν_{H} for users of type H and a bid of ν_{L} for users of type L. The content provider's value if the content provider does have access to the distribution data may be calculated using the formula:

π∫_{ν*}^{ν}^{_{H}}(ν_{H}−p)ƒ(p)dp+(1−π)∫_{νL}^{ν*}(ν_{L}−p)ƒ(p)dp.

The value of the distribution data determined when taking into consideration multiple content providers may be either higher or lower than when calculating based on two subsets of accurate data. In some implementations, the evaluation component 302 may calculate both values and present them to the user.

For example, a content provider may have zero value for the distribution data, if the content provider is able to exploit that the competing content providers are making different bids for the different types of users in such a way to ensure that the content provider always wins any impressions where the user is in the H group while not winning any impressions where the user is of in the L group.

As an alternative example, if the competing content providers are making bids that are strongly correlated with the content provider's value for the presentation opportunity, then the content provider may not be able to profitably bid in the auction without access to the distribution data provided by taking the competing bids into account.

In some arrangements, the evaluation component 302 may take into account the budgetary constraints of the content provider. The system may assume that the total amount of all of the bids made by the content provider cannot exceed the content provider's available budget. Therefore, if the content provider does not have the distribution data then the content provider may only bid in each auction that satisfied the constraint calculated using the formula:

∫₀^{b}pf(p)dp=B,

where b is the bid placed in the auction, and B is the advertising budget of the content provider.

In contrast, if the content provider has access to the distribution data, the content provider would bid b_{H} when the user is in the H group and b_{L} when the user is in the L group. Therefore, the bids satisfy the constraints calculated using the formula:

π∫₀^{b}^{_{H}}pƒ_{H}(p)dp+(1−π)∫ƒ₀^{b}^{_{L}}pƒ_{L}(p)dp=B.

The evaluation component 302 may calculate the value of the distribution data by selecting values of b_{H} and b_{L} that satisfy the constraint and maximize the value of the formula:

π∫₀^{b}^{_{H}}ν_{H}ƒ_{H}(p)dp+(1−π)∫₀^{b}^{_{L}}ν_{L}ƒ_{L}(p)dp=B.

When the content provider has access to the distribution data, the expected value of the placement can be calculated using the formula:

$${u}_{D} = π {v}_{H} {F}_{H} ( \frac{{v}_{H} {b}_{L}}{{v}_{L}} ) + ( 1 - π ) {v}_{L} {F}_{L} ( {b}_{L} ) - B ,$$

where F_{H} denotes the cumulative distribution function corresponding to the probability density function ƒ_{H} and F_{L} denotes the cumulative distribution function corresponding to the probability density function ƒ_{L}.

Therefore, the content providers value for the distribution data may be calculated using the formula:

$$π {v}_{H} {F}_{H} ( \frac{{v}_{H} {b}_{L}}{{v}_{L}} ) + ( 1 - π ) {v}_{L} {F}_{L} ( {b}_{L} ) - \overline{v} F ( b ) ,$$

where F denotes the cumulative distribution function corresponding to the probability density function ƒ.

While it is intuitive that the content provider's value for the distribution data may increase as a result of small increases in the content provider's budget, it may be less intuitive why it is possible for the content provider's value for the distribution data to decrease in the size of her budget. This scenario may arise when the content provider has a larger value for all advertising opportunities than any of the competing content providers. In this case, if a content provider has a large budget, having access to the distribution data hardly has any effect on the impressions that the content provider purchases since the content provider would purchase almost all impressions anyway. However, if the content provider has a smaller budget, then the distribution data may have a significant effect on which advertising opportunities the content provider wins. Thus the content provider's value for the distribution data may be decreasing in the size of the content provider's budget.

In some arrangements, the evaluation component 302 may calculate a value for a large number of different groups. As described above, the evaluation component 302 may accept or determine an amount the content provider is willing to pay for a placement opportunity is ν̅.

In this example, the value the content provider may expect from a placement opportunity may be calculated using the formula:

u_{ND}=∫₀^{∞}∫₀^{ν̅}(ν−p)ƒ(p)dpg(ν)dν,

where g is the probability density function corresponding to the distribution of values that the content provider may obtain for providing content to the various types of users.

Similarly, the value the content provider may expect from a placement opportunity if the content provider has the distribution data may be calculated using the formula:

u_{D}=∫₀^{∞}∫₀^{ν}(ν−p)ƒ(p)dpg(ν)dν.

Therefore, the value gain from having the distribution data may be calculated using the formula

u_{D}−u_{ND}=∫₀^{∞}∫_{ν̅}^{ν}(ν−p)ƒ(p)dpg(ν)dν.

In some arrangements, the evaluation component 302 may adjust the value of the distribution data based on the probability that the distribution data is incomplete or inaccurate. The content provider's value can be calculated using the formula:

ΣₛPr(s)ΣₜPr(t|s)∫₀^{b(s)}(νₜ−p)ƒₜ(p)dp,

where t indicates a representation of the type of the user that captures relevant features of the user that affect the content provider's value for providing content to that type of user (e.g. geographical location, etc.), s is the probability that a content provider will receive a particular signal, Pr(t|s) is the probability that a user is of type t given that the content provider receives the signal s, νₜ is the value the content provider has for providing content to a user of type t, and ƒₜ(p) is the probability density function corresponding to the distribution of the highest competing bid placed by competing advertisers for users of type t.

In this example, a bidding strategy for a content provider consists of a set of bids, b(s) following each possible realization of the signal s such that the following equation is satisfied for each possible realization of s for the parameter λ≧0 that is independent of the signal s. Moreover when the budget is unlimited then λ=0:

$$( λ + 1 ) b ( s ) = \frac{{\sum }_{t} Pr ( t \text{\textbar} s ) v ( t ) {f}_{t} ( b ( s ) )}{{\sum }_{t} Pr ( t \text{\textbar} s ) {f}_{t} ( b ( s ) )}$$

In some arrangements, the evaluation component 302 may combine multiple different sets of distribution data. Each set may have a marginal value that may not vary monotonically with the number of signals the content provider already has access to.

The value of a particular set of distribution data can depend critically on which other sets of distribution data the content provider is using to improve the distribution in other settings as well. For example, consider a setting in which there are several possible types of users and there are a variety of different sets of distribution data, each of which can identify one particular type of user with certainty, but contains no information about the other types of users. In this example, the value of a data source is still not independent of other signals; a particular set of distribution data may have almost no value when used in isolation, but be extremely valuable when used in combination with other distribution data.

For example, suppose the population is divided into three sets of equal size, and the content provider's value for the three types is 0.5; 0.8; and 1.0. The buyer competes against a uniform distribution on [0, 1]. Consider three different data sets, each of which accurately identifies all auctions of a given type but cannot distinguish between the other types of auctions. We denote them by D₁, D₂, and D₃, and assume that the buyer will bid the known expected value for each partition. The calculations below illustrate the content provider's value of delivering content using different sets of data sets. Let U(S) denotes the content provider's value from when the content provider has access to the distribution data sources in the set S. The evaluation component 302 may be computed as follows:

U()=⅓∫₀^{0.767}(0.5−p)dp+⅓∫₀^{0.767}(0.8−p)dp+⅓∫₀^{0.767}(1−p)dp=0.294145

U({D₁})=⅓∫₀^{-0.5}(0.5−p)dp+⅓∫₀^{0.9}(0.8−p)dp+⅓∫₀^{0.9}(1−p)dp=0.311667

U({D₂})=⅓∫₀^{-0.75}(0.5−p)dp+⅓∫₀^{0.8}(0.8−p)dp+⅓∫₀^{0.75}(1−p)dp=0.294167

U({D₃})=⅓∫₀^{-0.65}(0.5−p)dp+⅓∫₀^{0.65}(0.8−p)dp+⅓∫₀¹(1−p)dp=0.3075

U({D₁,D₂})=⅓∫₀^{-0.5}(0.5−p)dp+⅓∫₀^{0.8}(0.8−p)dp+⅓∫₀⁻¹(1−p)dp=0.315

In this example, knowing any two of the signals is sufficient to fully determine the group of the user.

The gain in value when set D₃ is used is given by the following formula:

U({D₃})−U()=0.013354

U({D₂,D₃})−U({D₂})=0.020833

U({D₁,D₃})−U({D₁})=0.0033

U({D₁,D₂,D₃})−U({D₁,D₂})=0

In some arrangements, the evaluation component 302 may compare data sets. For example, the evaluation component 302 may accept a quality metric and a cost for each set of distribution data. For two data sets, the first set having a cost of c₁ and a quality of q₁ and the second set having a cost c₂ and a quality q₂, the evaluation component 302 may determine that if

c₁−c₂≧ƒ̅(ν_{H}−ν_{L})²[⅔(q₁³−q₂³)−½(q₁²−q₂²)].

then the purchaser should always purchase the second set, where ƒ̅ is the maximum value that ƒ(p) ever assumes for values of p between ν_{L} and ν_{H}.

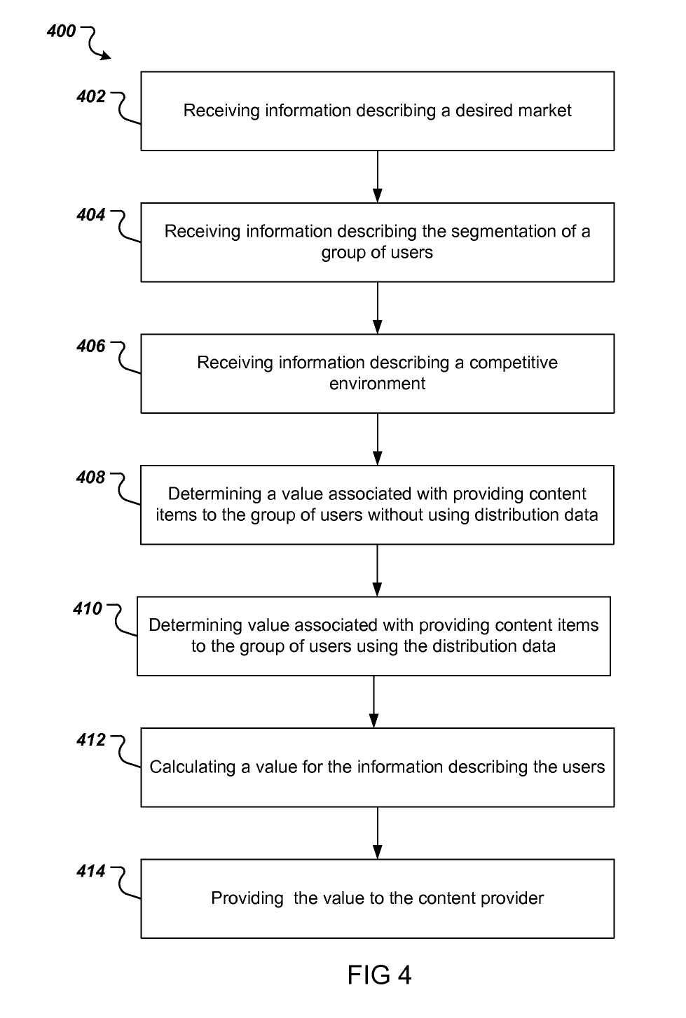

FIG. 4 is a flow chart 400 of a process for determining a value for distribution data. The process may be performed by a computer system, for example, the content management system 104 of FIG. 1.

Information describing a desired market is received (402). The information may include market distribution data and an indication of the value that a content provider places on each market segment.

Information describing a segmentation of a group of users is received (404). The information may include information about how the group is segmented. For example, the information may indicate that the distribution data segments the users by region of the country.

Information describing a competitive environment is received (406). The information describing the competitive environment may include a historical analysis of prices paid by competitors of the content provider in order to provide content items to users in the group of users.

A value associated with providing content items to the group of users without using the distribution data is determined (408). The value may be determined based on, for example, a historical record of values obtained by the content provider providing content items to similar groups of users.

A value associated with providing content items to the group of users using the distribution data is determined (410). The value may be determined as described above with respect to FIG. 3.

A value for the information describing a group of users is calculated (412). The value of the information may be calculated using the value associated with providing content items to the group of users without using the distribution data and the value associated with providing content items to the group of users using the distribution data.

The value is provided to the content provider (414).

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

For situations in which the systems discussed here collect personal information about users, or may make use of personal information, the users may be provided with an opportunity to control whether programs or features that may collect personal information (e.g., information about a user's social network, social actions or activities, a user's preferences, or a user's current location), or to control whether and/or how to receive content from the content server that may be more relevant to the user. In addition, certain data may be anonymized in one or more ways before it is stored or used, so that personally identifiable information is removed when generating monetizable parameters (e.g., monetizable demographic parameters). For example, a user's identity may be anonymized so that no personally identifiable information can be determined for the user, or a user's geographic location may be generalized where location information is obtained (such as to a city, ZIP code, or state level), so that a particular location of a user cannot be determined. Thus, the user may have control over how information is collected about him or her and used by a content server.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

1. A computer-implemented method comprising:
receiving, by a computer system, distribution data specifying segments of users in a given market;
for a given segment of the segments, receiving, by the computer system, competitive environment data for the given segment, with the competitive environment data representing prices paid by multiple content providers to provide content items to users in the given segment;
obtaining a first set of rules that define a first presentation value for a particular content provider for providing content items to users in the given segment, wherein the first presentation value is based on the competitive environment data for the given segment and excludes the distribution data, and wherein the first presentation value represents a first value that the particular content provider obtains by providing the content items without having access to the distribution data;
obtaining a second set of rules that define a second presentation value for the particular content provider for providing the content items to the users in the given segment, wherein the second presentation value is based on the competitive environment data for the given segment and also based on the distribution data, wherein the second presentation value represents a second value that the particular content provider obtains by providing the content items in response to accessing the distribution data;
obtaining a third set of rules that define a value of the distribution data for the particular content provider based on the first presentation value and the second presentation value; and
outputting the value of the distribution data for the particular content provider.

2. The method of claim 1, wherein calculating the value further comprises determining, based on the competitive environment data, a likelihood that a competitor will place a bid at a price between the first presentation value and the second presentation value.

3. The method of claim 1, further comprising:
receiving a second set of distribution data for the desired market; and
calculating a second value for the second set of distribution data based on second competitive environment data and a comparison of the second set of distribution data to the distribution data.

4. The method of claim 1, further comprising:
receiving a measure of quality associated with the distribution data; and
determining, based on the measure of quality, a probability that the distribution data accurately describes the desired market;
wherein the value is further based on the probability.

5. The method of claim 1, wherein the value is further based on a budgetary constraint.

6. The method of claim 1, wherein determining the second presentation value is based at least in part on a probability that the distribution data is complete.

7. A computer storage medium encoded with computer program instructions that when executed by one or more computers cause the one or more computers to perform operations comprising:
receiving distribution data specifying segments of users in a given market;
for a given segment of the segments, receiving competitive environment data for the given segment, with the competitive environment data representing prices paid by multiple content providers to provide content items to users in the given segment;
obtaining a first set of rules that define a first presentation value for a particular content provider for providing content items to users in the given segment, wherein the first presentation value is based on the competitive environment data for the given segment and excludes the distribution data, and wherein the first presentation value represents a first value that the particular content provider obtains by providing the content items without having access to the distribution data;
obtaining a second set of rules that define a second presentation value for the particular content provider for providing the content items to the users in the given segment, wherein the second presentation value is based on the competitive environment data for the given segment and also based on the distribution data, wherein the second presentation value represents a second value that the particular content provider obtains by providing the content items in response to accessing the distribution data;
obtaining a third set of rules that define a value for the distribution data for the particular content provider based on the first presentation value and the second presentation value; and
outputting the value of the distribution data for the particular content provider.

8. The medium of claim 7, wherein calculating the value further comprises determining, based on the competitive environment data, a likelihood that a competitor will place a bid at a price between the first presentation value and the second presentation value.

9. The medium of claim 7, wherein the computer program further comprises computer program instructions that when executed by one or more computers cause the one or more computers to perform operations comprising:
receiving a second set of distribution data for the desired market; and
calculating a second value for the second set of distribution data based on second competitive environment data and a comparison of the second set of distribution data to the distribution data.

10. The medium of claim 7, wherein the computer program further comprises computer program instructions that when executed by one or more computers cause the one or more computers to perform operations comprising:
receiving a measure of quality associated with the distribution data; and
determining, based on the measure of quality, a probability that the distribution data accurately describes the desired market;
wherein the value is further based on the probability.

11. The medium of claim 7, wherein the value is further based on a budgetary constraint.

12. The medium of claim 7, wherein determining the second presentation value is based at least in part on a probability that the distribution data is complete.

13. A system comprising:
one or more computers and one or more storage devices storing instructions that are operable, when executed by the one or more computers, to cause the one or more computers to perform operations comprising:
receiving distribution data specifying segments of users in a given market;
for a given segment of the segments, receiving competitive environment data for the given segment, with the competitive environment data representing prices paid by multiple content providers to provide content items to users in the given segment;
obtaining a first set of rules that define a first presentation value for a particular content provider for providing content items to users in the given segment, wherein the first presentation value is based on the competitive environment data for the given segment and excludes the distribution data, and wherein the first presentation value represents a first value that the particular content provider obtains by providing the content items without having access to the distribution data;
obtaining a second set of rules that define a second presentation value for the particular content provider for providing the content items to the users in the given segment, wherein the second presentation value is based on the competitive environment data for the given segment and also based on the distribution data, wherein the second presentation value represents a second value that the particular content provider obtains by providing the content items in response to accessing the distribution data;
obtaining a third set of rules that define a value of the distribution data for the particular content provider based on the first presentation value and the second presentation value; and
outputting the value of the distribution data for the particular content provider.

14. The system of claim 13, wherein calculating the value further comprises determining, based on the competitive environment data, a likelihood that a competitor will place a bid at a price between the first presentation value and the second presentation value.

15. The system of claim 13, wherein the instructions are further operable, when executed by the one or more computers, to cause the one or more computers to perform operations comprising:
receiving a second set of distribution data for the desired market; and
calculating a second value for the second set of distribution data based on second competitive environment data and a comparison of the second set of distribution data to the distribution data.

16. The system of claim 13, wherein the instructions are further operable, when executed by the one or more computers, to cause the one or more computers to perform operations comprising:
receiving a measure of quality associated with the distribution data; and
determining, based on the measure of quality, a probability that the distribution data accurately describes the desired market;
wherein the value is further based on the probability.

17. The system of claim 13, wherein the value is further based on a budgetary constraint.

18. The system of claim 13, wherein determining the second presentation value is based at least in part on a probability that the distribution data is complete.
